(19) United States
(12) Patent Application Publication
(10) Pub. No.: US 2006/0182516 A1
(43) Pub. Date: Aug. 17, 2006

(54) Framer's point

(75) Inventor: Vincent T. Kozyrski, Plainville, CT (US)

Correspondence Address: O'SHEA, GETZ & KOSAKOWSKI, P.C., 1500 MAIN ST., SUITE 912, SPRINGFIELD, MA, 01115, US

(73) Assignee: THE FLETCHER-TERRY COMPANY, FARMINGTON, CT (US)

(21) Appl. No.: 11/060,257

(22) Filed: Feb. 17, 2005

(51) Int. Cl. F16B 15/00

(52) U.S. Cl. 411/478

(57) ABSTRACT

A framer's point is provided that includes a lengthwise-extending centerline, a first body portion disposed on a first side of the centerline, and a second body portion disposed on a second side of the centerline. The first body portion and the second body portion extend laterally outward from the centerline with an obtuse included angle. The present framer's point is stackable in a columnar linear stack.

### BACKGROUND OF THE INVENTION

1. Technical Field

This invention relates to framer's points in general, and to framer's points adaptable for use in a mechanical driving device.

2. Background Information

Framer's points are used to retain materials (e.g., backing board, foam board, cardboard, photo, artwork, etc.) within a frame. The framer's point is driven into the frame proximate the outermost piece of framed material to hold the materials within the pocket of the frame. To insure that the framed materials are held in the desired position, it is desirable to drive the point in close proximity to the material. [0003] Numerous framer's point embodiments exist. Few of those embodiments, however, can be easily driven into a frame in close proximity to the framed material, particularly by a mechanical driving device. Frames are made from a multitude of different materials; e.g., soft woods, hard woods, etc. As a result, a framer's point must have sufficient mechanical strength to withstand the force required to insert the frame without buckling. The point should preferably also have a geometry that facilitates its retention within the frame.

A key aspect of a framer's point is the “height” of the point, which is defined as the distance extending between the surface of the point intended to by proximate with the framing material, and outermost opposite surface(s). The framer's point height is important because frame pockets are typically shallow and a point height that extends outside of the pocket can scratch the wall or other surface on which the frame is suspended. Historically, framer's points are flat. The length of a framer's point is less critical. The geometric requirements for a glazier's point (i.e., a point used to hold a glass pane within a window frame) are the opposite. The height of the glazier's point is less critical because the point is covered in glazing compound typically applied at about a 45° angle. The length of the glazier's point must be shorter than the height of a framer's point to ensure that the glazier's point does not extend outside of the glazing compound.

Historically, early framer's points were driven into the frame by hand. Today, it is highly desirable to have a point that can be driven by a mechanical driving device. U.S. Pat. No. 4,699,307, issued to the assignee of the present application, discloses a mechanical driving device for driving flat framer's and glazier's points. A stack of points disposed within the device are actuated into the frame one at a time. To achieve the requisite point strength, the points are made from particular materials, at a predetermined thickness. Although these points and point driver work well, it is always advantageous to provide a point that is less expensive to manufacture and performs as well or better than existing points.

What is needed, therefore, is a point that is adaptable for use in a mechanical driving device, one that possesses the requisite mechanical strength to be used with a variety of different frame materials, one that has a geometry that permits it to be used as a framer's point, one that has a geometry that facilitates its retention within the frame, and one that performs as well or better than existing framer's points.

### DISCLOSURE OF THE INVENTION

According to the present invention, a framer's point is provided that includes a lengthwise-extending centerline, a first body portion disposed on a first side of the centerline, and a second body portion disposed on a second side of the centerline. The first body portion and the second body portion extend laterally outward from the centerline with an obtuse included angle.

According to an embodiment of the present invention, a framer's point is provided that includes a lengthwise-extending centerline, a first body portion, and a second body portion. The first body portion is disposed on a first side of the centerline. The first body portion includes a first lateral guide edge extending substantially parallel to the centerline, and a first head section that includes a first leading edge. The second body portion is disposed on a second side of the centerline. The second body portion includes a second lateral guide edge extending substantially parallel to the centerline, and a second head section that includes a second leading edge. The first body portion and the second body portion extend laterally outward from the centerline with an obtuse included angle. The first leading edge extends between the second leading edge and the first lateral guide edge, and the second leading edge extends between second leading edge and the second lateral guide edge.

According to an aspect of the present invention, a stack of the present invention framer's points is provided. [0010] There are several advantages provided by the present invention framer's point that illustrate the differences between the present framer's point and those of the prior art. For example, the body configuration of the present invention wherein a pair of body portions are disposed on each side of a centerline with an obtuse included angle disposed there between, provides considerable mechanical integrity. As a result, the present point can be made with thinner and/or less rigid materials than is possible with a flat point for the same spectrum of frame materials, and therefore less expensively. The thinner point material also facilitates insertion of the point into the frame material, and retention once inserted. Insertion is facilitated, for example, because less force is required to insert the thinner point. Retention is facilitated, for example, because the thinner point more deeply penetrates the frame material, thereby increasing the collective retention forces on the point.

Another advantage of the present point configuration is that it can be assembled in a linear column (i.e., a “stack”) that can be used in a mechanical driving device. Numerous prior art points were developed to be inserted manually, and have geometries that do not permit column stacking. As a result they do not permit assembly in a columnar form that can be used in a self-feeding mechanical driving device.

Another advantage of the present point is that it can be inserted so that at least a segment of the point body portions is biased against the framing materials. The configuration of the present point body portions with an obtuse included angle, and the convergence of the leading edges, creates a normal force (having an “x” component parallel to the point centerline, and a “y” component perpendicular to the centerline) on the leading edges during insertion that is sufficient to create a moment on the point. The moment force, in turn, biases the point body portions downwardly toward the framing materials. If the point is inserted in close enough proximity to the framing materials, at least a segment of the point body portions will be biased against the framing materials. The biased point advantageously biases the framing materials in the selected position.

Another advantage of the present framer's point stems from its lateral guide edges, extending lengthwise from the leading edges that facilitate application of the point with a mechanical driving device. Some prior art points (e.g., U.S. Pat. Nos. 714,516 and 820,192) have either no, or only limited, lateral guide edges extending parallel to the lengthwise centerline of the point, which centerline defines the insertion direction of the point. The lateral guide edges are significant when the point is used within a mechanical driving device. Typically, driving devices include a channel that intersects with a magazine holding the stack of points. The next-to-be-inserted point is passed into the channel, and a push plate actuates the point through the channel and into the frame. The lateral guide edges ensure that the point is traveling in the desired direction before and after contact with the frame. Inadequate guide edges, or the lack of guide edges, can result in a point rotating away from the desired insertion direction during insertion and possible malfunction of the driving device. The potential for such a malfunction increases with the hardness of the frame material. The present invention framer's point minimizes the opportunity of such a malfunction by having lateral guide edges that intersect with and extend lengthwise from the leading edges. The advantage of the guide edges within a mechanical driving device is increased in the embodiment of the present framer's point wherein the first and second lateral guide edges are substantially flat surfaces that are parallel with one another. The parallel flat surface guide edges create a desirable fit within the channel of the driving device, and therefore advantageous guidance therein.

These and other objects, features, and advantages of the present invention will become apparent in light of the detailed description of the present invention.

### BRIEF DESCRIPTION OF THE DRAWINGS

FIG. 1 is a diagrammatic planar view of a present invention framer's point.

FIG. 2 is a diagrammatic end view of a present invention framer's point.

FIG. 3 is a diagrammatic end view of a stack of the present invention framer's points.

FIG. 4 is a diagrammatic side view of a stack of the present invention framer's points.

FIG. 5 is a diagrammatic sectioned view of a point drive into a frame, biased against framing material disposed within the pocket of the frame.

### DETAILED DESCRIPTION OF THE INVENTION

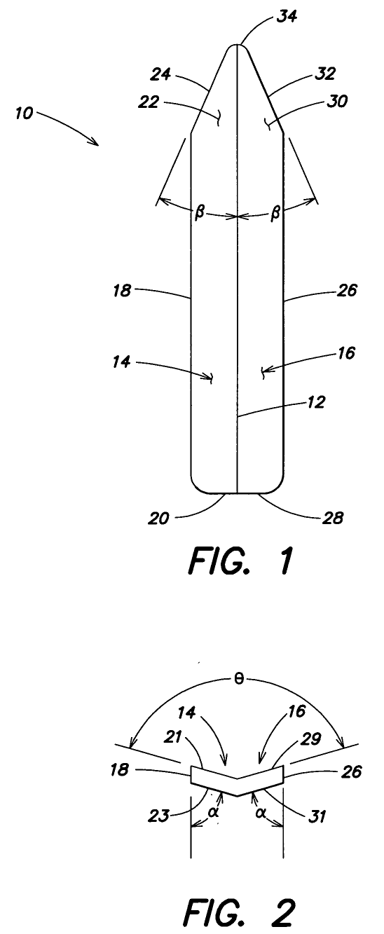

Referring to FIGS. 1-4, a framer's point 10 is provided that includes a lengthwise-extending centerline 12, a first body portion 14, and a second body portion 16. The point 10 can be made from a variety of different materials. Low carbon steel is an example of an acceptable material.

The first body portion 14 is disposed on a one side of the centerline 12 and the second body portion 16 is disposed on the opposite side of the centerline 12, albeit not 180° opposite. The first body portion 14 includes a first lateral guide edge 18, a first driving edge 20, a first head section 22, an upper surface 21, and a lower surface 23. The first lateral guide edge 18 extends substantially parallel to the centerline 12. The first head section 22 includes a first leading edge 24 that extends between the first lateral guide edge 18 and a second leading edge 32 as will be described below. The first driving edge 20 extends substantially perpendicular between the first lateral guide edge 18 and the centerline 12.

The second body portion 16 includes a second lateral guide edge 26, a second driving edge 28, a second head section 30, an upper surface 29, and a lower surface 31. The second lateral guide edge 26 extends substantially parallel to the centerline 12. The second head section 30 includes the second leading edge 32 that extends between the second lateral guide edge 26 and the first leading edge 24 as will be described below. The second driving edge 28 extends substantially perpendicular between the second lateral guide edge 26 and the centerline 12.

Referring to FIG. 2, in a preferred embodiment, the first and second lateral guide edges 18,26 are substantially flat surfaces that are parallel with one another. Each parallel surface is at a non-perpendicular angle with the upper surface 21,29 and lower surface 23,31 of the respective first and second body portions 14,16. To illustrate the parallel orientation of the first and second lateral guide edges 18,26, FIG. 2 shows the lateral guide edges 18, 26 disposed at equal angles “α” from the lower surfaces 23,32. The substantially flat parallel lateral guide edges 18,26 facilitate guidance of the point 10, and attachment of the point 10 within a stack 36 as will be described below.

As described above, the first body portion 14 and the second body portion 16 extend laterally outward from the centerline 12. The first and second body portions 14,16 are relatively positioned such that an obtuse angle “θ” is formed as the included angle there between. An obtuse angle is defined as being less that 180° and more than 90°. In a preferred embodiment, the included angle θ is at or between 170° and 130°. In a most preferred embodiment, the included angle θ is at or between 160° and 140°.

The first and second leading edges 24,32 are angularly disposed relative to the centerline 12. Preferably, the leading edges 24,32 are disposed at equal angles “β” from the lengthwise extending centerline 12. Equal angles “β” create a tip 34 of the point 10 that coincides with, and is symmetrical about, the lengthwise-extending centerline 12. In a preferred embodiment, the included angle (i.e., 2×β) between the leading edges 24,32 is at or between 70° and 30°. In a most preferred embodiment, the included angle (i.e., 2×β) is at or between 60° and 40°.

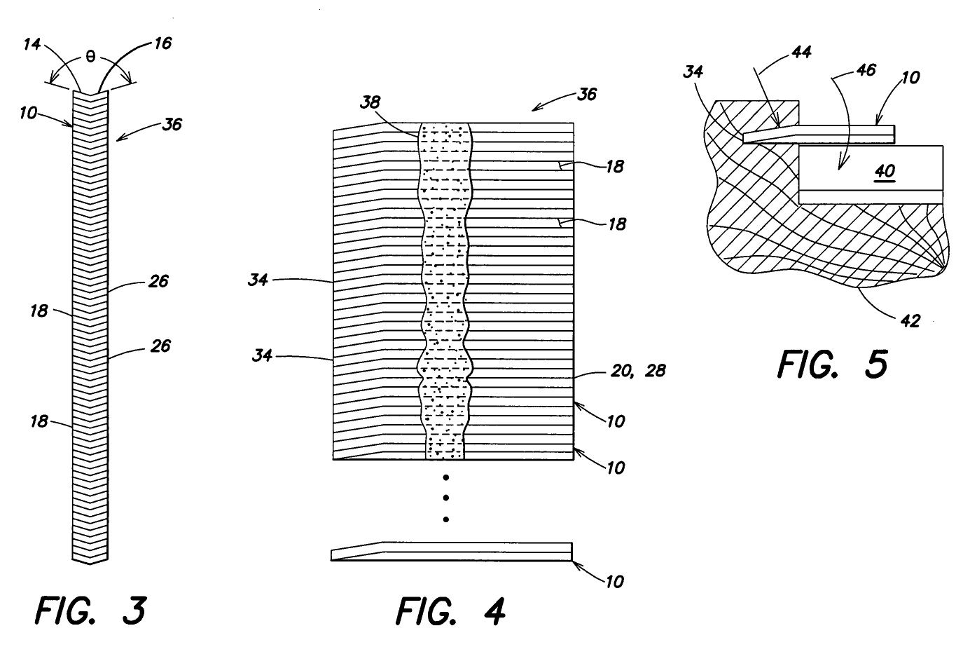

In an embodiment of the present invention, the present points 10 are arranged in a linear column stack 36, held together by an adhesive element 38. In some embodiments, one or more strips of adhesive tape are disposed in contact with the one or both lateral guide edges 18,26. In other embodiments, the stack of points 10 are held together by a layer of glue or other material applied to the lateral guide edges 18,26 in a liquid or semi-solid state that subsequently hardens sufficiently to keep the stack as a unitary assembly. Other mechanisms for maintaining the stack of points 10 as a unitary assembly may be used alternatively. The embodiment of the present framer's point 10 wherein the first and second lateral guide edges 18,26 are substantially flat surfaces, parallel with one another, provides a desirable surface on which the adhesive element 38 can be applied. As can be seen in FIG.3, the parallel surfaces provide additional surface area to which the adhesive element can be attached, rather than a series of points that would be present if the guide edges 18,26 were perpendicular to the upper surface 21,29 and lower surface 23,31 of the respective point 10.

The geometric configuration of the present framer's point 10, and in particular the obtuse included angle “θ” disposed between, and the symmetry of the first and second body portions 14,16, enables each point 10 to nest within the adjacent point 10. Collectively, the present points 10 are readily stackable in a linear column stack 36. As a result, the stack 36 can be easily inserted within the magazine of a mechanical driving device (not shown), and received within the point actuation mechanism of the device.

Referring to FIG.5, the present point 10 can be installed manually or using a mechanical driving device. In each instance, the point 10 is placed in close proximity to the framing materials 40. The tip 34 of the point 10 is oriented toward the frame 42, preferably perpendicular to the frame 42. Force is applied to one or both of the driving edges 20,28, and the point 10 is driven into the frame 42. As the point 10 is driven into the frame 42, the reactant force 44 acting normal to the leading edges 24,32 applies a moment 46 to the point 10 that biases the point 10 toward the framing material 40. If the point 10 is inserted in the frame 42 in close enough proximity to the framing materials 40, at least a segment of the point body 14,16 will biased into contact with and against the framing materials 40.

Although this invention has been shown and described with respect to the detailed embodiments thereof, it will be understood by those of skill in the art that various changes in the form and detail thereof may be made without departing from the spirit and scope of the invention.

What is claimed is:

1. A framer's point, comprising:
a lengthwise-extending centerline;
a first body portion disposed on a first side of the centerline; and
a second body portion disposed on a second side of the centerline;
wherein the first body portion and second body portion extend laterally outward from the centerline with an obtuse included angle.

2. The framer's point according to claim 1, wherein the obtuse included angle is at or between 170° and 130°.

3. The framer's point according to claim 1, wherein the obtuse included angle is at or between 160° and 140°.

4. The framer's point according to claim 1, wherein the first body portion includes a first lateral guide edge, and the second body portion includes a second lateral guide edge, and the first and second lateral guide edges are each substantially flat, and parallel with one another.

5. A framer's point, comprising:
a lengthwise-extending centerline;
a first body portion disposed on a first side of the centerline, the first body portion having a first lateral guide edge extending substantially parallel to the centerline, and a first head section that includes a first leading edge; and
a second body portion disposed on a second side of the centerline, the second body portion having a second lateral guide edge extending substantially parallel to the centerline, and a second head section that includes a second leading edge;
wherein the first body portion and the second body portion extend laterally outward from the centerline with an obtuse included angle; and
wherein the first leading edge extends between the second leading edge and the first lateral guide edge, and the second leading edge extends between second leading edge and the second lateral guide edge.

6. The framer's point according to claim 5, wherein the obtuse included angle is at or between 170° and 130°.

7. The framer's point according to claim 5, wherein the obtuse included angle is at or between 160° and 140°.

8. The framer's point according to claim 5, wherein the first leading edge and the second leading edge are disposed at acute angles relative to the centerline.

9. The framer's point according to claim 5, wherein an included angle between the first leading edge and the second leading edge is at or between 70° and 30°.

10. The framer's point according to claim 5, wherein an included angle between the first leading edge and the second leading edge is at or between 60° and 40°.

11. The framer's point according to claim 5, wherein the first lateral guide edge extends between the first leading edge and a first driving edge, and the second lateral guide edge extends between the second leading edge and a second driving edge.

12. The framer's point according to claim 5, wherein the first and second lateral guide edges are each substantially flat, and parallel with one another.

13. A stack of framer's points, comprising:
a plurality of points, each having
a lengthwise-extending centerline;
a first body portion disposed on a first side of the centerline, the first body portion having a first lateral guide edge extending substantially parallel to the centerline, and a first head section that includes a first leading edge; and
a second body portion disposed on a second side of the centerline, the second body portion having a second lateral guide edge extending substantially parallel to the centerline, and a second head section that includes a second leading edge;
wherein the first body portion and the second body portion extend laterally outward from the centerline with an obtuse included angle; and
wherein the first leading edge extends between the second leading edge and the first lateral guide edge, and the second leading edge extends between second leading edge and the second lateral guide edge;
said points nested to form a columnar linear stack; and
an adhesive element extending along the columnar linear stack.

14. The stack according to claim 13, wherein the first and second lateral guide edges of each of the plurality of points are each substantially flat, and parallel with one another.
